(19) United States
(12) Patent Application Publication
(10) Pub. No.: US 2006/0173797 A1
(43) Pub. Date: Aug. 3, 2006

(54) Method for tracking mail piece data

(76) Inventors: Robert Sheehan, Ashburn, VA (US); Dennis Gilham, Essex (GB)

Correspondence Address: PERMAN & GREEN, 425 POST ROAD, FAIRFIELD, CT, 06824, US

(21) Appl. No.: 11/047,286

(22) Filed: Jan. 31, 2005

(51) Int. Cl. G06F 17/00

(52) U.S. Cl. 705/404

(57) ABSTRACT

A method for tracking data related to mail pieces. The method is provided having steps of: assigning a mail delivery service code to the mail piece; storing the mail delivery service code in a database; receiving data corresponding to the mail piece; storing the data in the database; and linking the mail delivery service code to the data in the database.

### BACKGROUND

1. Field of the Invention

The exemplary embodiments and methods described herein relate to a method of tracking data related to mail pieces.

2. Brief Description of Related Developments

Mail pieces may be generated from multiple originators or sources within an organization. Any one piece of mail may have multiple types of data corresponding to it. Examples of such data include the originator, destination and return address. Data relating to the piece of mail may be read or added subsequent to the piece being finished. One example of such data originates at a mailing or franking machine. Mailing machines enable users to frank one or more mail items by printing a stamp representing the amount paid by the sender. For example, U.S. Pat. Nos. 5,243,908; 5,683,190; 5,526,271; 6,607,095; 6,050,054; 5,293,465; 5,688,729; all of which are incorporated herein by reference in their entirety; disclose franking machines which may comprise franking heads, feeders, folders and user interfaces as examples. Here, a separate mail delivery service code is added to the item or piece after the item is fully finished. A problem arises when a user would like to relate mail pieces generated at different sources to data subsequently received relating to the mail piece. It would be advantageous to create a system that is capable to provide a service that tracks and posts data relating to mail pieces.

### SUMMARY OF THE EXEMPLARY EMBODIMENTS

In accordance with one exemplary embodiment of the present invention, a method for tracking data related to a mail piece is provided having steps of: assigning a mail delivery service code to the mail piece; storing the mail delivery service code in a database; receiving data corresponding to the mail piece; storing the data in the database; and linking the mail delivery service code to the data in the database.

In accordance with another exemplary embodiment of the present invention, a method for tracking data related to mail pieces is provided having steps of: assigning a machine readable information based indicia to a mail piece corresponding to a unique number; printing the machine readable information based indicia on the mail piece; posting the unique number to a database on an internet service provider's server; posting a destination address corresponding to the mail piece to the database; and linking the unique number to the destination address in the database.

In accordance with another exemplary embodiment of the present invention, a method for tracking data related to mail pieces for multiple users is provided having steps of: providing a database on an internet service provider's server; providing a user access application on the server enabling the multiple users to access the database; storing data corresponding to originators of the mail pieces in the database; storing unique numbers corresponding to machine readable information based indicia on the mail pieces in the database; storing additional data corresponding to the mail pieces in the database; and linking the data corresponding to originators and the additional data to the unique numbers in the database.

### BRIEF DESCRIPTION OF THE DRAWINGS

The foregoing aspects and other features of the present invention are explained in the following description, taken in connection with the accompanying drawings, wherein:

FIG. 1 shows a prior art addressed envelope;

FIG. 2 shows a block diagram of a system in which the method of the present invention could be utilized; and

FIG. 3 shows a flow diagram of a method for tracking data related to mail pieces.

### DETAILED DESCRIPTION OF THE EXEMPLARY EMBODIMENTS

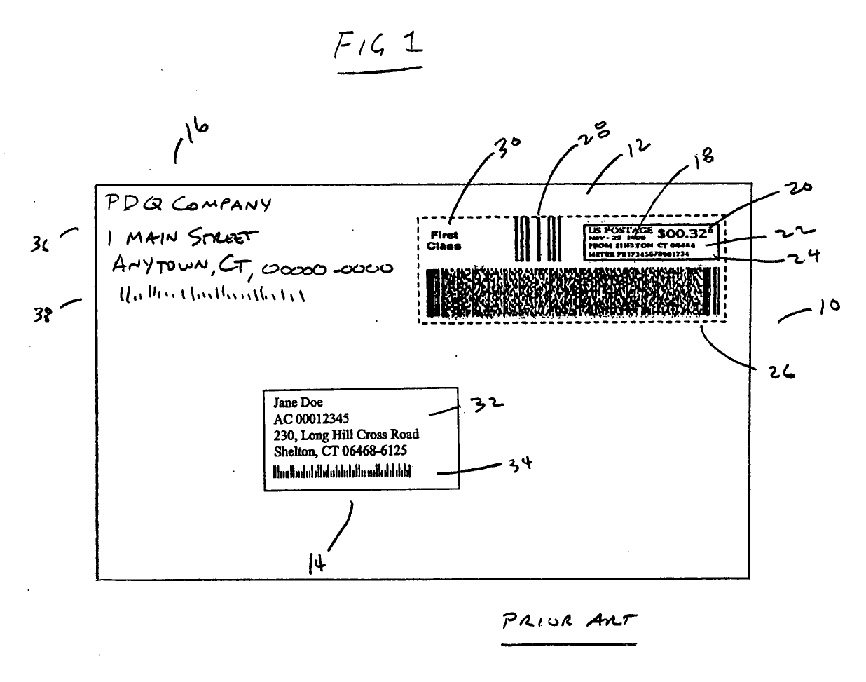

Referring to FIG. 1, there is shown an envelope 10 having a United States Postal Service (USPS) Information Based Indicia (IBI) 12, a destination address 14 and a return address 16. The indicia 12 has a date 18, a dollar amount 20, place of origin 22 postal meter serial number 24, encrypted bar code 26 and FIM 28 and class indication 30. The destination address 14 includes a written destination 32 and bar code 34 corresponding to the written destination 32. The return address 16 includes a written return 36 and bar code 38 corresponding to the written return 36. Although the present invention will be described with reference to the exemplary embodiments shown in the drawings, it should be understood that the present invention can be embodied in many alternate forms of embodiments. In addition, any suitable size, shape or type of elements or materials could be used.

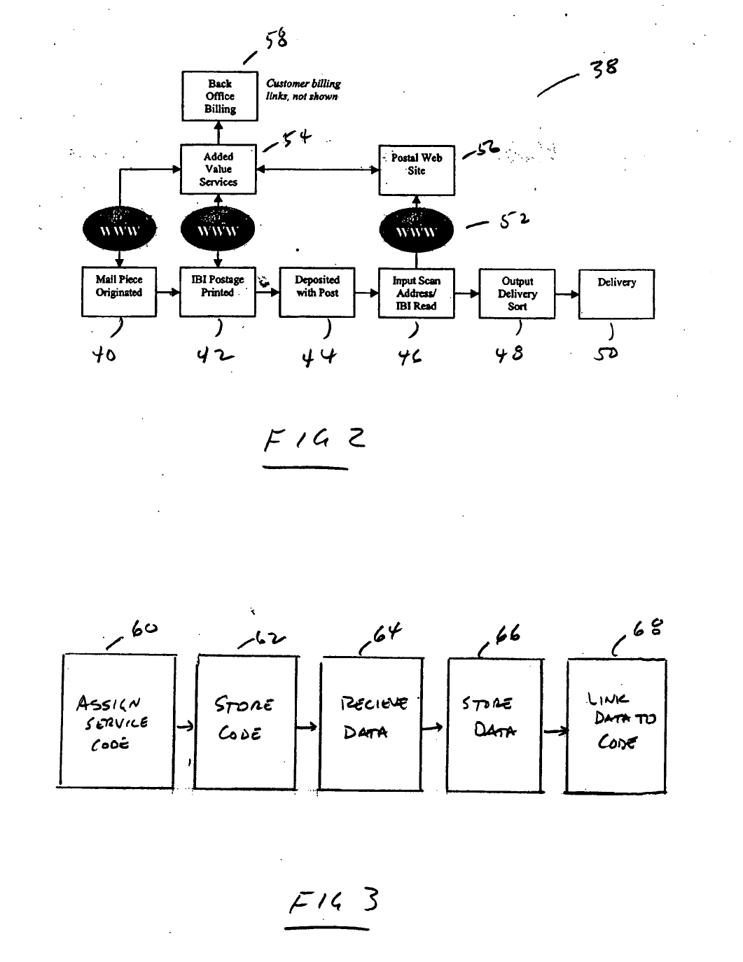

Referring now to FIG. 2, there is shown a block diagram of a system 38 in which the method of the present invention could be utilized. A mail piece is originated by a user at 40 where data, such as destination address, return address or delivery type may be assigned. The data may be stored, for example, transferred over the world wide web 52 to a value added service application 54. In alternate embodiments, the data may be collected further down stream. In alternate embodiments, the data may be stored locally or stored over a network. A unique number is assigned, for example, an IBI code and printed on the mail piece at 42, such as with a franking machine. The unique number may be stored, for example, transferred over the world wide web 52 to a value added service application 54. In alternate embodiments, additional data may be transferred, such as destination address, where a user such as the originator or a postal service may access the data from application 54. The mail piece is deposited with a postal service at 44 where the postal service scans the IBI and/or the destination address or other data. Here, additional data may be generated, such as tracking numbers for example. The data may be posted to website 56 and accessed by application 54. In alternate embodiments, the data may be directly sent to application 54 by the postal service or accessed from the application by the postal service directly eliminating additional scanning at the postal service. Application 54 links data relating to individual mail pieces in a database. The mail is sorted at 48 and subsequently delivered at 50. A billing link 58 may be provided to track and bill for user access to service application 54. Alternately, the function of link 58 may be provided as part of application 54. Although the different functions and data access points are shown linked by the world wide web, other suitable access or data communication methods may be provided, for example, networked or wireless or other suitable methods.

Referring also to FIG. 3, there is shown a flow diagram of a method for tracking data related to a mail piece. At step 60, a mail delivery service code is assigned to the mail piece. At step 62, the mail delivery service code is stored in a database. At step 64, data is received corresponding to the mail piece. At step 66, the data is stored in the database. At step 68, the mail delivery service code is linked to the data in the database. The delivery service code may comprise, for example, a USPS information based indicia and may include, for example, a user field having data corresponding to the originator. The information based indicia may be machine readable information and correspond to a unique number where the indicia is printed on the mail piece. The machine readable information based indicia may be printed on the mail piece with a franking machine and where the franking machine may post the unique number to the database, for example, over the internet. The unique number may be posted to the database, for example, on an internet service provider's server. If available at an earlier time or at the same time, a destination address corresponding to the mail piece may also be posted to the database and linked to the unique number, for example, to be accessed by a postal service or user. In alternate embodiments, other information, such as originator may be similarly posted. Receiving data corresponding to the mail piece may, for example involve reading an address on the mail piece at a postal service office; reading the mail delivery service code on the mail piece at the postal service office; posting the address and the mail delivery service code on a postal service website; and reading the address and the mail delivery service code through a separate application on a separate server from the postal website. The data may comprise, for example, a destination address, a tracking number, a postal reading location and/or a delivery date. In alternate embodiments, more or less additional data may be provided. Data may be posted and linked to the unique number and or to other data in the database, such as a tracking number, originator or a postal reading location corresponding to the mail piece. A further step may be provided of storing the originator in the database and linking the originator with the mail delivery service code.

A user access application 54 may be provided enabling the user to access the unique number or data linked to the unique number. The user access application 54 may be provided on a server where the user access application 54 is accessible by a user over the internet and where the user can search for other unique numbers corresponding to other mail pieces originated by the user. In this manner, a method for tracking data related to mail pieces for multiple users may be provided. Here, a database is provided on an internet service provider's server in addition to the user access application enabling multiple users to access the database. Data may be stored corresponding, for example, to originators of the mail pieces or unique numbers corresponding to machine readable information based indicia on the mail pieces in the database. At a subsequent time, additional data corresponding to the mail pieces may be stored in the database and linked to the data previously stored, for example, linking tracking numbers to the unique number or originator in the database. The additional data may comprise destination addresses where the destination addresses are read from a postal web site 56 after being scanned and posted by the postal service at 46 and 56. Alternately, the additional data may comprise tracking numbers where the tracking numbers and the unique numbers are read from a postal web site 56 after being scanned and posted by the postal service. The user access application 54 allows the user to search the database as a function of the data provided, for example, by originator or additional data corresponding to destination address. The user access application 54 may segregate the additional data and the unique numbers by user where different users may independently access the segregated data simultaneously. The application 56 may track the number of times a user accesses the application 56, for example, for billing purposes. The application 56 may provide different levels of access rights, for example, two or more different levels of access rights corresponding to administrative users and/or originating users.

In this manner, mail pieces generated at different sources within an organization may be related to information subsequently received from special mail delivery services, such as, track and trace. Here, the mail pieces may be identified and consequently information, such as, contents, purpose, application or originator with information derived from a non-related mail delivery service code. When a separate mail delivery service code is added to an item after the item is fully finished, the subsequent information received concerning the delivery of the item may be related back to the source information. The application 54 achieves this automatically and in a cost effective way. The application 54 may maintain a record containing data, for example, originators information, such as, mail service, tracking code, originator, destination address, date and any special comments. Alternatively, the destination address could be captured at 40 or 42, such as at the time a unique mail piece identifier is attached or printed, such as, with an Information Based Indicia (IBI) as specified by the USPS. A scanner of suitable performance and capacity may be used at 40 or 42 for this purpose in combination with adequate processing and data storage capabilities either locally or remotely. Additionally, a job/originator reference may be included as a line with the address or entered manually, which would not be problematical for batches of mail originating from the same job/source. Here, the date may be generated automatically. Application 54 consolidates and links data relating to information that exists at different places and at different times in digital form and consolidates this information in a usable form, for example, at the originators location in a cost effective solution that can be readily implemented and without significant changes to the mail flow processes of a mixed mail environment.

Most business mail in a mixed mail environment arrives in the mailroom preaddressed. Addresses may be printed on the main document with window envelopes or printed directly on the envelope or label attached to the mail piece or hand written. Modern franking machines print postage containing machine readable information, such as the IBI specified by the USPS. The USPS indicia contains such readable information as the mailer license reference, date, the service code, item number, paid postage and validation means plus a user field that could be set to print a selected job or originator, for example. The IBI represents a unique number identifying any individual mail piece. The IBI for closed systems, such as, postage meters typically does not contain information on the delivery address. Although feasible as discussed above, it is difficult and expensive to obtain the delivery address from the mail piece automatically at the time of printing the IBI. Post Offices like the USPS typically read the IBI while processing the delivery of the mail for revenue protection and for added value services, such as, tracking and delivery notification. The IBI information may be captured when the face of the envelope is scanned to read the delivery address for sorting and routing purposes. A delivery point barcode may then be printed and used for subsequent handling. This avoids having to OCR process the envelope each time. Alternately, barcodes may be printed by senders making the delivery process more efficient where the sender may receive a reduction in postage for this purpose. In each case, the delivery address information may be obtained at the same point as the IBI information although the IBI information may be processed at a later time. Similarly if any other mail delivery coded information is attached to the envelope it may be processed in a like manner. Post Offices typically have high-performance mail sorting systems with wide area readers that can automatically read most addresses with different mail item formats, different printed character fonts, different font sizes and qualities. Similarly, most hand script written addresses can be read automatically. Addresses that cannot be read fully automatically are read using video captured images and processed via remote reading desks where manual entries are made to complete the correct address file. Additionally, an alphanumeric information line, such as account reference and originator may be included with the address. Captured IBI or unique identifier information may also used for tracking and added value mail delivery services, such as, delivery notification. The captured IBI details, for example, the mail piece identification code/number, date sent and date read plus the postal reading location may be posted on a postal web site so that the customer can access the required information. Typically, the postal delivery company has the means to post both the captured destination address as well as the corresponding IBI details. Application 54 provides a database linking the data, for example, the two pieces of information, the unique identifier and the delivery address information for each customer/sender where the customer may include recipients, postal services or otherwise. The database may be established on a service provider's server with a dedicated application containing the necessary access security, searching and reporting capabilities. Here, a user or customer will not require any special software or hardware to access the information. Access may be available via the Internet to any user having the appropriate access rights; for example, assigned administrator or user. A user, for example, the originator may search and find a required item by a combination of relevant criteria including the delivery address, date, job number etc. Periodic files may be uploaded from each franking machine, e.g. daily. Alternately, data may be uploaded as it becomes available. The files containing the relevant IBI information, such as the license number, date, item numbers, mail services and user field information, if required. As the Post office scans and reads the mail items the delivery address and status information may be added. Customer enquiries and reports may then be managed directly from this service and the service may be paid for on a fee and/or individual transaction basis. The remote server may meter directly individual usage and output accounting information to a customer billing/payment system 58. The remote service providers system may further be used in a reverse sense to download to individual users franking machines any special delivery mail service codes to be printed according to the customer's delivery service selections. Here, a user may avoid the use of separate adhesive labels and ensure that codes are efficiently managed as unique entities. Application 54 provides a seamless solution providing integrated postal delivery services for mailers who need to relate the information for any mail piece with the non-related tracking/status information received via a mail delivery company. Additionally, application 54 provides a turn-key solution for users requiring no significant change to internal mixed mail flow processes. Further, application 54 provides a simple way in which mail delivery companies can process large quantities of mail delivery flow information without significant changes to current methods.

It should be understood that the foregoing description is only illustrative of the invention. Various alternatives and modifications can be devised by those skilled in the art without departing from the invention. One such example is where other configurations of databases or servers may also be used. Accordingly, the present invention is intended to embrace all such alternatives, modifications and variances which fall within the scope of the appended claims.

What is claimed is:

1. A method for tracking data related to a mail piece, comprising:
assigning a mail delivery service code to the mail piece;
storing the mail delivery service code in a database;
receiving data corresponding to the mail piece;
storing the data in the database; and
linking the mail delivery service code to the data in the database.

2. The method of claim 1 wherein the delivery service code comprises a USPS information based indicia.

3. The method of claim 1 wherein the delivery service code comprises a USPS information based indicia, and wherein the data comprises a destination address.

4. The method of claim 1 wherein the delivery service code comprises a USPS information based indicia, and wherein the data comprises:
a destination address;
a tracking number;
a postal reading location; and
a delivery date.

5. The method of claim 1 wherein receiving data corresponding to the mail piece comprises:
reading an address on the mail piece;
reading the mail delivery service code on the mail piece;
posting the address and the mail delivery service code on a website; and
reading the address and the mail delivery service code from the website.

6. The method of claim 1 further comprising storing the originator in the database and linking the originator with the mail delivery service code.

7. The method of claim 1 wherein the mail delivery service code includes a user field having data corresponding to the originator.

8. A method for tracking data related to mail pieces, comprising:
assigning a machine readable information based indicia to a mail piece corresponding to a unique number;
printing the machine readable information based indicia on the mail piece;
posting the unique number to a database on an internet service provider's server;
posting a destination address corresponding to the mail piece to the database; and
linking the unique number to the destination address in the database.

9. The method of claim 8 further comprising posting data comprising a tracking number and a postal reading location corresponding to the mail piece to the database; and linking the unique number to data in the database.

10. The method of claim 8 further comprising posting an originator corresponding to the mail piece to the database; and linking the unique number to the originator in the database.

11. The method of claim 8 further comprising providing a user access application enabling the user to access the unique number or data linked to the unique number.

12. The method of claim 8 further comprising providing a user access application on the server enabling the user to access the unique number or data linked to the unique number, wherein the user access application is accessible by a user over the internet and wherein the user can search for other unique numbers corresponding to other mail pieces originated by the user.

13. The method of claim 8 wherein the machine readable information based indicia is printed on the mail piece with a franking machine, and wherein the franking machine posts the unique number to the database.

14. A method for tracking data related to mail pieces for multiple users comprising:
a. providing a database on an internet service provider's server;
b. providing a user access application on the server enabling the multiple users to access the database;
d. storing data corresponding to originators of the mail pieces in the database;
d. storing unique numbers corresponding to machine readable information based indicia on the mail pieces in the database;
e. storing additional data corresponding to the mail pieces in the database; and
f. linking the data corresponding to originators and the additional data to the unique numbers in the database.

15. The method of claim 14 wherein the additional data comprises destination addresses, and wherein the destination addresses are read from a postal web site.

16. The method of claim 14 wherein the additional data comprises tracking numbers, and wherein the tracking numbers and the unique numbers are read from a postal web site.

17. The method of claim 14 wherein the user access application allows the user to search the database by originator or additional data corresponding to destination address.

18. The method of claim 14 wherein the user access application segregates the additional data and the unique numbers by user.

19. The method of claim 14 wherein the application tracks the number of times a user accesses the application.

20. The method of claim 14 wherein the application provides at least two different levels of access rights corresponding to administrative users and originating users.
